(19) United States
(12) Patent Application Publication
(10) Pub. No.: US 2001/0047617 A1
(43) Pub. Date: Dec. 6, 2001

(54) Portable hydroponic garden apparatus

(76) Inventor: Christopher Todd Blossom, Windsor, CT (US)

Correspondence Address: CANTOR COLBURN, LLP, 55 GRIFFIN ROAD SOUTH, BLOOMFIELD, CT, 06002

(21) Appl. No.: 09/825,238

(22) Filed: Apr. 3, 2001

Related U.S. Application Data
(60) Provisional application No. 60/194,331, filed on Apr. 3, 2000.

(51) Int. Cl. A01G 31/00

(52) U.S. Cl. 47/62 R

(57) ABSTRACT

This invention offers advantages and alternatives over the prior art by providing a portable hydroponic garden apparatus. The apparatus generally includes a frame and a reservoir for holding nutrient solution. One or more receptacles are disposed across the reservoir above the nutrient solution and are designed to hold plants. A solution distribution assembly is provided for delivering the nutrient solution from the reservoir to the one or more receptacles so that the nutrient solution is discharged over a surface of the one or more receptacles and the nutrient solution is fed to the plants. The one or more receptacle have drainage means so that the nutrient solution drains back into the reservoir. Thus, the nutrient solution is constantly circulated throughout the apparatus and more importantly the nutrient is aerated in the process. Aeration of the nutrient solution leads to better plant growth because the level of air within the nutrient solution is optimized.

### CROSS REFERENCE TO RELATED APPLICATION

This application claims the benefit of U.S. Provisional Patent Application No. 60/194,331 filed on Apr. 3, 2000, entitled “Hydroponic Garden Apparatus”, which is herein incorporated by reference in its entirety.

### TECHNICAL FIELD

The present invention relates generally to hydroponic plant growth systems for providing nutrient solution to plants in a plurality of growth chambers, and more particularly, to an apparatus for accomplishing this function automatically in such a manner as to provide uniformity of nourishment to the plants in the various growth chambers.

### BACKGROUND OF THE INVENTION

A variety of systems are known for providing hydroponic nutrient solution or water to plants in a plurality of growth chambers. However, some of these systems rely at least in part on gravity flow of nutrient solution, thus requiring that different components of the system be located on different levels. There is thus a need, met by the present invention, for a system not relying at all on gravity flow of nutrient solution to or from the growth chambers, and instead providing for filly powered pressurized flow of nutrient solution to the various growth chambers, so that the system may be used with all components on a single level, e.g. resting simply on a single floor.

Some systems for distribution of hydroponic nutrient solution, while providing for distribution of nutrient solution to each of the growth chambers, do so in a manner which does not provide for uniformity of nourishment of the various plants, either by having the nutrient solution flow sequentially through the various growth chambers, so that the nutrient solution reaching growth chambers which are further down in the flow sequence will have a poorer nutrient supply remaining, as compared with that reaching chambers higher up in the flow sequence, due to absorption of a portion of the nutrient in the higher chambers; or by having a common main flow line from which streams flow out to the various chambers, so that, due to the resulting pressure drop along the flow line, the plants in chambers further downstream on the common main flow line will receive a smaller flow rate of nutrient solution than those in chambers further upstream on the flow line.

Still, other systems provide hydroponic growth conditions by employing a nutrient film technique (NFT) or ebb and flow technique. These systems also result in unequal distribution of water and nutrients.

Additionally, these systems, due to unequal or inefficient water and/or nutrient distribution or otherwise often do not sufficiently aerate the water. Such aeration is necessary for proper plant health. In this respect, many growing systems are deficient.

Many known systems are not adaptable for a user's particular purposes. That is, many systems are of a fixed size and include a fixed number of and disposition of growth chambers. Additionally, such systems are not adaptable for switching from one growth technique to another, nor can they employ more than one growth technique at a time. Also, such system are often large, expensive, and difficult to manage.

Thus there is a need, which is met by the present invention, for a hydroponic garden system that operates by separate, identical pressurized flow lines, to equally, consistently, and accurately distribute nutrients and water throughout various growth chambers and properly aerate the water and, further, a hydroponic growth system which is adaptable to various growth techniques and to a user's preferences and is portable, simple to manufacture, inexpensive, and easy for the user to manage and use.

### SUMMARY OF THE INVENTION

This invention offers advantages and alternatives over the prior art by providing a portable hydroponic garden apparatus. The apparatus generally includes a frame and a reservoir for holding nutrient solution. One or more receptacles are disposed across the reservoir above the nutrient solution and are designed to hold plants. A solution distribution assembly is provided for delivering the nutrient solution from the reservoir to the one or more receptacles so that the nutrient solution is discharged over a surface of the one or more receptacles and the nutrient solution is fed to the plants. The one or more receptacle have drainage means so that the nutrient solution drains back into the reservoir.

Thus, the nutrient solution is constantly circulated throughout the apparatus and more importantly the nutrient is aerated in the process. Aeration of the nutrient solution leads to better plant growth because the level of air within the nutrient solution is optimized. One notable advantage of the present invention is that it is portable and is self-contained so that it is easily and conveniently used in any number of settings.

Furthermore, Applicant's apparatus is adaptable to a user's specific growing preferences. For example, the apparatus is fully adjustable to accommodate various numbers and types of plants, various growing positions of the plants, various lighting and growing techniques, etc. Also, a number of individual components may be added or removed from the apparatus to custom fit the apparatus according to the user's preferences and needs.

Additionally, Applicant's apparatus is of a simple construction which allows for easy and inexpensive manufacture.

The above-described and other features and advantages of the present invention will be appreciated and understood y those skilled in the art from the following detailed description, drawings, and appended claims.

### BRIEF DESCRIPTION OF THE DRAWINGS

The present invention will now be described, by way of example only, with reference to the accompanying drawings in which:

FIG. 1 is a perspective view of a portable hydroponic garden apparatus according to a first embodiment of the present invention;

FIG. 2 is a cross-sectional view of a solution reservoir and distribution assembly for use in the apparatus of FIG. 1;

FIGS. 3A-3C are side elevational views of plant holding members according to various different embodiments and for use in the apparatus of claim 1;

FIG. 4A is a perspective view of a plant holding member of a first embodiment and for use with the apparatus of FIG. 1;

FIG. 4B is a top plan view of two adjacent clamps for use with the plant holding member of FIG. 4A;

FIG. 5 is a perspective view of an individual plant holding member for use with the apparatus of FIG. 1;

FIG. 6 is a perspective view of a portable hydroponic garden apparatus according to a second embodiment of the present invention;

FIG. 7 is a perspective view of a portable hydroponic garden apparatus according to a third embodiment of the present invention;

FIG. 8 is a perspective view of a portable hydroponic garden apparatus according to a fourth embodiment of the present invention;

FIG. 9 is a perspective view of a portable hydroponic garden apparatus according to a fifth embodiment of the present invention; and

FIG. 10 is a perspective view of a portable hydroponic garden apparatus according to a sixth embodiment of the present invention.

### DETAILED DESCRIPTION OF THE PREFERRED EMBODIMENT

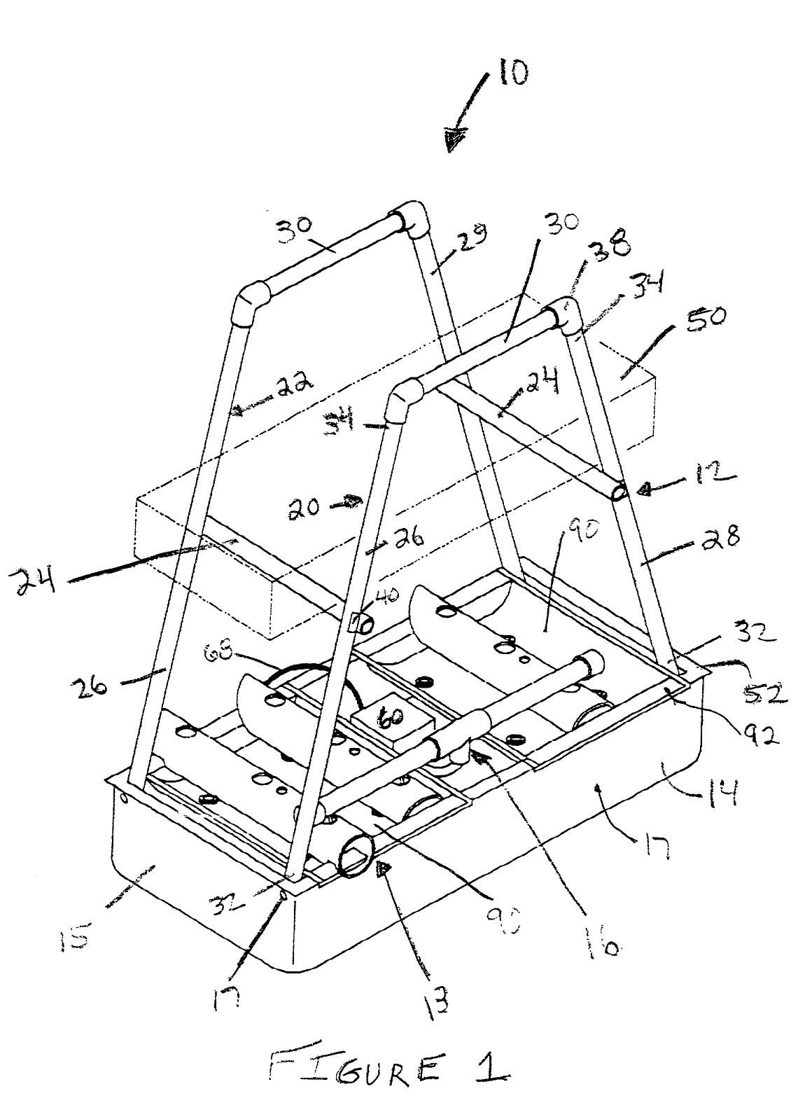

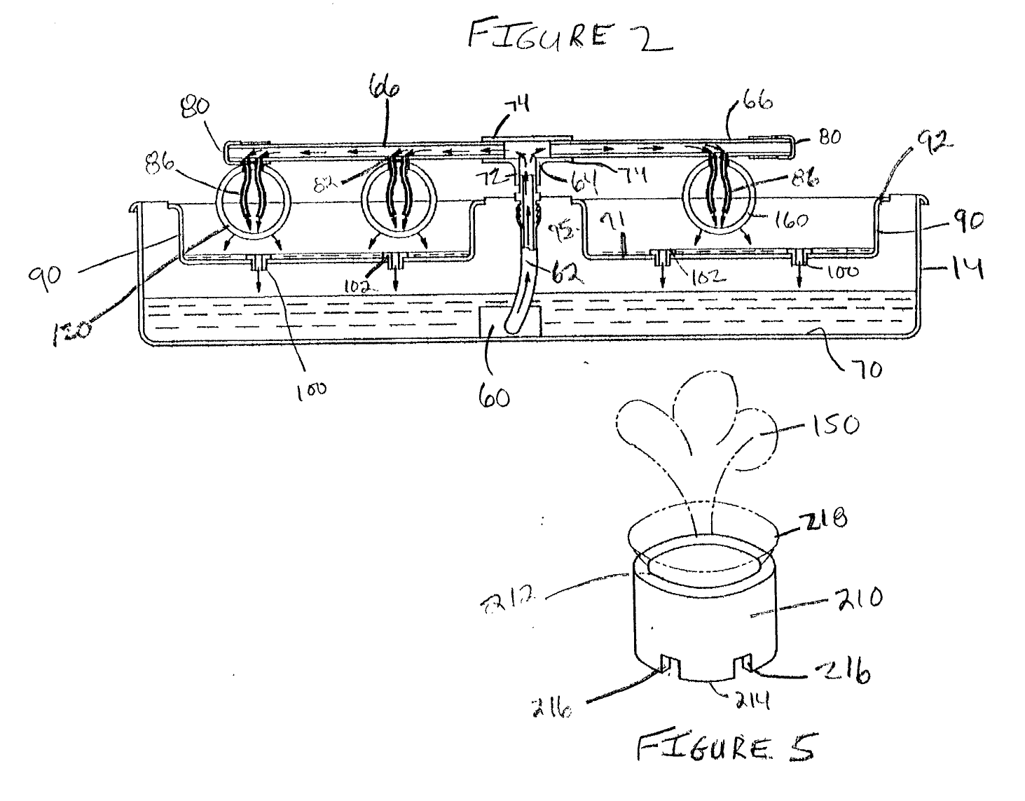

Referring to FIGS. 1-2 in which an exemplary hydroponic garden apparatus according to a first embodiment is shown and generally indicated at 10. The apparatus 10 generally comprises a frame 12, a reservoir member 14, a solution distribution assembly 16 and one or more plant holding members generally indicated at 18. In the illustrated first embodiment, the frame 12 comprises a multi-pieced frame having a first frame member 20 and an opposing second frame member 22 spaced thereapart. The frame 12 also includes a pair of spaced cross support members 24. In the illustrated embodiment, the first frame member 20 is formed of first and second vertical members 26, 28 and a first connector member 30. The members 26, 28, 30 may be formed of any number of materials so long as the desired support is provided and in one preferred embodiment, the members 26, 28, 30 comprise plastic tubular members. Each of the first and second vertical members 26, 28 has a first end 32 and an opposing second end 34 with the first ends 32 being affixed to the reservoir member 14 as will be described in greater detail hereinafter. The first connector member 30 extends between the second ends 34 and the first and second vertical members 26, 28 are angled inward at the second ends 34 so that the distance between the second ends 34 is less than the distance between the first ends 32. A pair of connectors 38 is used to connect the seconds ends 34 to the first connector member 30. One exemplary connector 38 comprises an L-shaped tubular connector which receives the second ends 34 and the first connector member 30. It will be appreciated that the second frame member 22 includes the same components and is constructed in an identical manner and for ease of explanation a detailed description of the second frame member 22 will be omitted and the like elements of second frame member 22 are numbered alike.

One cross support member 24 extends between the first vertical members 26 of the first and second frame members 20, 22 at a location between the first and second ends 32, 34 thereof and the other cross support member 24 extends between the second vertical member 28 of the first and second frame members 20, 22 at a similar location. Preferably, the cross support members 24 lie in the same horizontal plane. In the illustrated embodiment, the cross support members 24 are formed of a similar material as the other components of the frame 12 and therefore comprise plastic tubular members. The cross support members 24 may be affixed to the first and second vertical members 26, 28 by any number of techniques. For example, a clamp, generally indicated at 40 is used to affix the cross support members 24 to the first and second vertical members 26, 28. One type of suitable clamp 40 comprises a U-clamp which captures each cross support member 24 and is attached to the first and second vertical members 26, 28. The pair of cross support members 24 provide a planar support surface above the reservoir member 14. This planar support surface may be used for any number of purposes and in one exemplary embodiment, a light assembly 50 is supported by the cross support members 24 and extends across the apparatus 10. A portion of the light assembly 50 may extend past each cross support member 24 so that the light assembly 50 extends to edges of the reservoir member 14. Any number of light assemblies 50 may be used including conventional fluorescent lighting and also special growing light fixtures may be used. In place of the light assembly 50, a trellis structure may be used and the plants may grow around and in the trellis network which provides the desired support and growing surfaces.

The reservoir member 14 comprises a structure for holding a predetermined amount of a growing solution which often comprises a mixture of water and a nutrient additive. The nutrient additive may itself be a combination of a number of nutrients including minerals which provide nourishment for the plants so that the plants may grow properly and be healthy. The reservoir member 14 may take any number of shapes and sizes and one preferred reservoir member 14 comprises a rectangular member formed of plastic. The reservoir member 14 has a peripheral rim 52 which extends around an upper edge of the reservoir member. This peripheral rim 52 provides a location for a user to grip and lift the reservoir member and it also is used to locate and secure some of the plant holding members 18. The first ends 32 of each of the first and second vertical members 26, 28 are received within the inside of the reservoir member 14 and are affixed to an end wall 15 thereof. For example, a fastener 17, such as a bolt, may be used to secure the first end 32 to the end wall 15 and provide the necessary structural support for the frame 12.

The solution distribution assembly 16 generally includes a submersible electrically powered pump 60 an intake member 62, a main distributor member 64, and one or more side distributor members 66 which couple with the main distributor member 64. The pump 60 is of a conventional submersible fluid pump design and is connected by a power cord 68 to an outlet (not shown) or the pump 60 may be connected to a timer (not shown) which itself plugs into a standard power outlet. The timer may then be programmed so that the pump 60 operates only at selected times. The pump 60 is placed onto a bottom surface 70 of the reservoir member 14 and is operated below the level of the nutrient solution. The intake member 62 connects the pump 60 to the main distributor member 64 and in the illustrated embodiment comprises a fluid carrying member which is preferably flexible. For example, the intake member 62 may be formed of a flexible plastic tubing.

The main distributor member 64 serves to distribute the solution within the apparatus 10 to various growing cells as will be described in greater detail hereinafter. The main distributor member 64 may take any number of shapes and generally includes an intake section 72 which receives the nutrient solution from the intake member 62. In the illustrated embodiment, the main distributor member 64 is a T-shaped member having a pair of side extensions 74 which receive and direct the nutrient solution from the intake section 72. The main distributor member 64 shown in FIG. 2 is tubular in nature. The side distributor member 66 comprises an elongated member which couples to one of the side extensions 74 of the main distributor member 64 and is designed to transport the nutrient solution within the apparatus 10. The length of the side distributor member 66 may be varied according to the desired application and one exemplary type of side distributor member 66 comprises an elongated tubular member which has a diameter slightly less than the diameter of the side extension 74 so that the side distributor member 66 frictionally is received within the side extension 74. Of course, it will be appreciated that one side distributor member 66 can be removed and another of different size may be inserted into the side extension 74. The side distributor member 66 thus is closed ended at one end and in one embodiment, an end cap 80 is placed at the one end opposite the main distributor member 64.

The end cap 80 is a solid capping member which prevents flow of the nutrient system from ends of distributor member 66. In another embodiment, the end cap may include tubing or other such solution distribution elements to effect selective discharge of the solution from the distributor member at the ends thereof.

According to the present invention, the side distributor member 66 has one or more outlets 82 formed therein for directing the nutrient solution flowing therethrough to individual or group growing cells. The outlets 82 may simply comprise openings formed in the side distributor member 66 or the outlets 82 preferably include a small section of tubing 86 extending from the side distributor member 66. This small section of tubing 86 permits the pumped nutrient solution to be focused more into a flowing stream which is directing into the growing cells. One exemplary type of tubing 86 comprises a flexible plastic tubing which is often referred to as elastomeric spaghetti tubing. The illustrated solution distribution assembly 16 in FIG. 2 shows one side distributor member 66 having two outlets 82. It being understood that the side distributor members 66 may be designed to fit the specific needs of a given application in terms of the number and size of outlets 82 and the size of the side distributor member 66 itself. The solution distribution assembly 16 is thus designed to pump and circulate the nutrient solution throughout the apparatus 10 and this process advantageously introduces air into the nutrient solution. As is well known in hydroponic gardening, the aeration of the nutrient solution provides the plants with a more optimum mix of water and air which leads to better growth and the plants will accordingly be healthier.

The plant holding members 18 of the apparatus 10 is formed of a number of individual components. One or more support and growing receptacles, generally indicated at 90, are provided for positioning the plants within the apparatus 10 at a location above the nutrient solution level but below the solution distribution assembly 16 so that the nutrient solution flows from the outlets 82 and into the growing receptacles 90. In the illustrated embodiment, each growing receptacle 90 comprises a rectangular member having a bottom surface 91 and four side walls which extend upwardly from the bottom surface 91. The receptacle 90 is thus open only at a top section thereof which receives the plants and also the flowing nutrient solution and provides a window to light and sunshine.

The receptacle 90 preferably includes a lip 92 which serves to secure and position the receptacle 90 within the reservoir member 14. More specifically, the lip 92 extends over the peripheral rim 52 of the reservoir member 14 so as to seat the receptacle 90 within the reservoir member 14 above the nutrient solution level.

Alternatively, the receptacle may be positioned within the reservoir member such that the lip does not contact the rim. In this position, the lip provides an overflow spill surface over which the nutrient solution may flow from the receptacle to the reservoir, as discussed below.

The receptacle 90 also includes a number of positioned drainage outlets 100 designed to drain the nutrient solution from the receptacle 90 back into the reservoir member 14 where it is recirculated by pump 60. One or more of the drainage outlets 100 preferably includes a nutrient solution adjustment member 102 which permits the level of nutrient solution contained within the receptacle 90 to reach a certain level before the nutrient solution flows through the outlets 100 into the reservoir member 14.

One particularly useful adjustment member 102 comprises a stand pipe which is inserted into the outlet 100 and is adjusted therein so that a portion of the stand pipe 102 extends above the outlet 100. The nutrient solution will thus be collected within the receptacle 90 until the level of the nutrient solution reaches the top of the stand pipe 102. At his time, the nutrient solution will flow into the stand pipe 102 and through the outlet 100 and flow into the reservoir member 14.

This feature advantageously permits the level of nutrient solution within the receptacle 90 to be monitored and adjusted. For example, some type of plants may need or thrive in an environment where there the plant or the root structure thereof sits within a significant amount of nutrient solution. As previously mentioned, the nutrient solution which is circulated within the apparatus 10 is aerated and this provides the needed oxygen to the plants. Plants will draw up the water it needs and therefore when the bottom of the plant sits within the circulated nutrient solution, the plant will draw up the aerated water. Without the correct amount of air, the plants will not flourish and many indoor plants die in a home environment not because the plant was over watered but because the over watering did not allow the plant to get the necessary air.

In another embodiment, the adjustment member 102 comprises a plug fitted for insertion into the outlets 100. The plug prevents flow of the nutrient solution through the outlets, thus creating a pool to form in the receptacle 90. The pool may be allowed to swell until the solution spills over the lip 92 and into the reservoir. This condition may be desirable for the growth of certain types of plants and to effect increased aeration of the nutrient solution caused by agitation of solution in the reservoir.

Utilization of the adjustment member 102 as described and contemplated in the present invention enables variation of growing techniques utilized in the apparatus. That is, for example, an ebb and flow technique may be effected in one receptacle or reservoir unit while a pressurized system or a nutrient film technique is utilized in another. This permits tremendous flexibility for the operator and allows adaptability for a variety of plants and/or growing conditions.

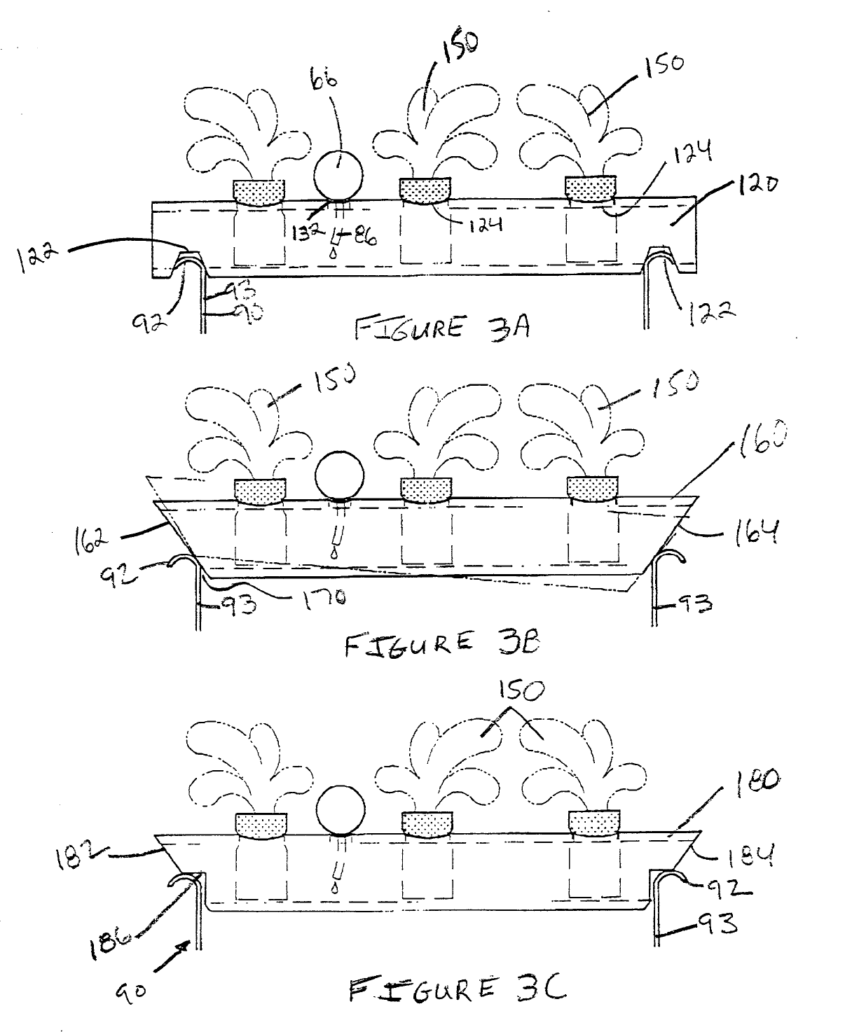

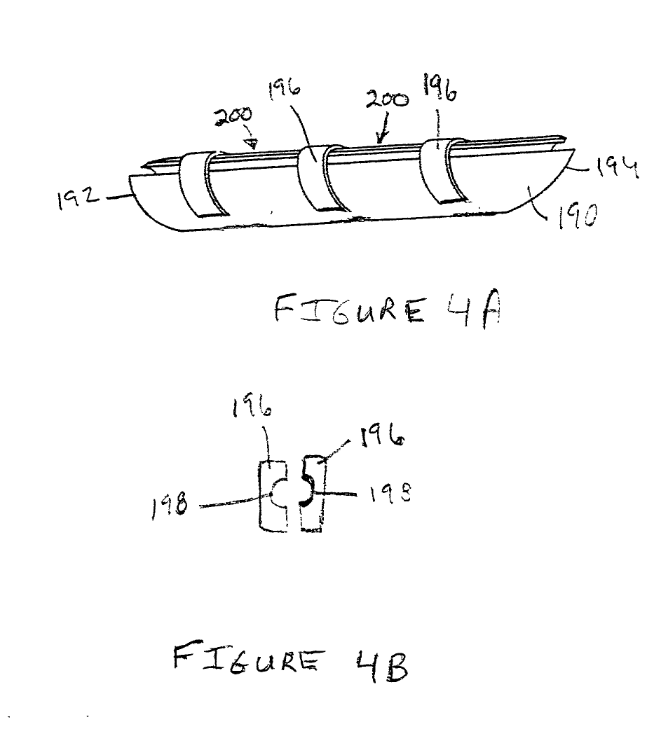

Now referring to FIGS. 1-3C. FIGS. 3A-3C show various plant holding members according to several different embodiments. FIG. 3A shows a plant holding member 120 having a catch groove 122 formed therein for receiving one lip 92 of the receptacle 90 so as to secure and locate the plant holding member 120 relative to the receptacle 90. As shown in the Figure, the lip 92 is slightly curved and the catch groove 122 is sized to frictionally receive and removably lock the plant holding member 120 in place. The plant holding member 120 has a number of openings 124 formed therein for receiving a corresponding number of plants, generally indicated at 150. In addition, an inlet opening 132 is formed in the plant holding member 120 and is designed to receive tubing 86 which carries the nutrient solution from the solution distribution assembly 16 to the inside of the plant holding member 120. Therefore, the inlet opening 132 is sized to receive the tubing 86 and the other openings 124 are sized to receive a number of plants 150. The illustrated plant holding member 120 comprises a generally tubular member formed of a rigid plastic. Because the receptacle 90 is also preferably formed of a plastic material, the lip 92 may be slightly flexed outward so as to permit the plant holding member 120 to be disposed between the lip 92. For drainage purposes, a number of drainage ports (not shown) may be formed in the plant holding member 120 which permit the nutrient solution flowing from the solution distribution assembly 16 to drain into the receptacle 90 where the nutrient solution in turn drains into the reservoir member 14.

FIG. 3B illustrates a plant holding member 160 according to another embodiment of the present invention. The plant holding member 160 is similar to plant holding member 120 with the exception of the end portions thereof. The plant holding member 160 has first and second ends 162, 164 which are beveled and the catch groove 122 is eliminated. The beveled ends 162, 164 are preferably open-ended so that nutrient solution is permitted to flow along the length of the plant holding member 160 and exit at ends 162, 164. FIG. 3B shows the plant holding member 160 in first and second positions with the second position being shown in phantom. The plant holding member 160 is retained between walls 93 of the receptacle 90 by disposing ends 162, 164 between the walls 93 of the receptacle 90. Because receptacle 90 is preferably formed of a plastic material, the walls 93 thereof may be slightly flexed outward to receive the plant holding member 160 and then upon release, the walls 93 engage the ends 162, 164 to secure the plant holding member 160. Due to the beveled nature of the ends 162, 164, a gap generally indicated at 170 is formed between each end 162, 164 and the walls 93. This gap 170 serves as a drainage point for the nutrient solution to drain from the plant holding member 160 to the receptacle 90 after having provided aerated nutrient solution to the plants 150. The plant holding member 160 is shown in the second position in which end 164 is angled downward relative to the other end 162. The nutrient solution will thus flow to end 164 and the gap 170 formed thereat will provide the drainage means for the plant holding member 160. It will be appreciated that one of ends 162, 164 may not be beveled as is shown in FIGS. 1 and 2.

FIG. 3C shows yet another embodiment of a plant holding member 180 which is similar to both plant holding members 120 and 160 with like elements being numbered alike. In this embodiment, ends 182, 184 include a shoulder 186 which is designed to receive and seat against the walls 93 and lips 92 of the receptacle 90. In the illustrated embodiment, the shoulder 186 is L-shaped and frictionally engages the walls 93 so as to securely locate the plant holding member 180 therebetween. While, there may be a slight drainage gap between ends 182, 184 and walls 93, it is preferable to have a number of drainage ports (not shown) formed in the plant holding member 180.

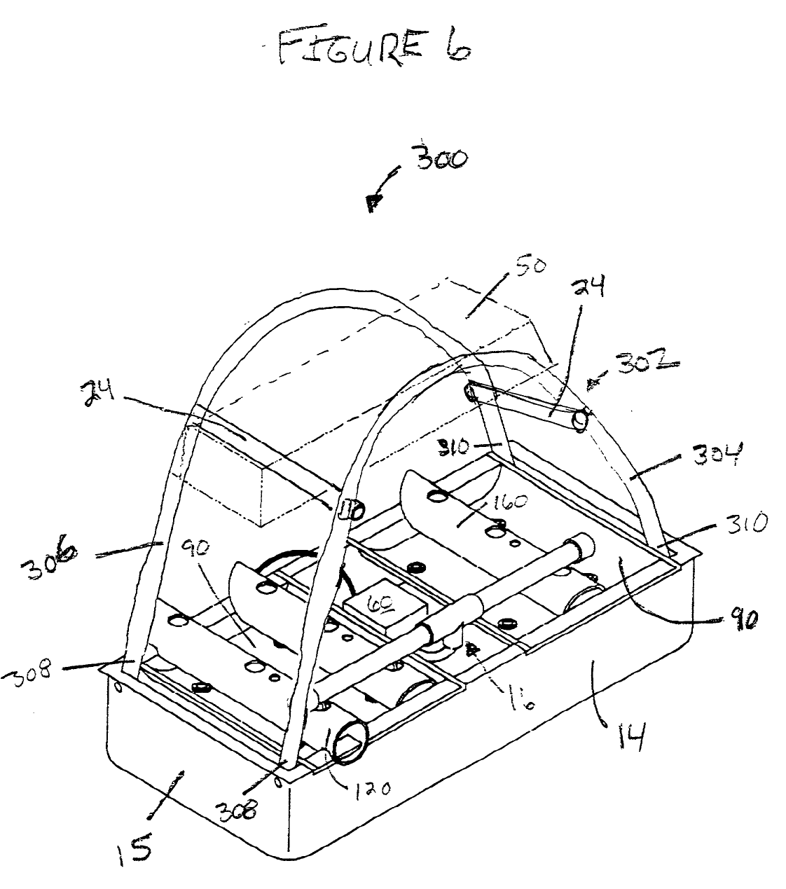

FIG. 4A is a perspective view of another plant holding member 190. Plant holding member 190 is similar to the other members and preferably is formed of a tubular member. The tubular member is cut in half longitudinally and preferably includes beveled ends 192, 194. A number of slidable clamps 196 are provided to define individual plant cells 200. The clamps 196 are preferably formed of the same plastic tubular material which permits the clamp 196 to be slightly flexed outward so as permit the clamps 196 to snap around the plant holding member 190. The resiliency of the clamps 196 permits the clamps 196 to slide along the length of the plant holding member 190 thereby allowing the size of the individual plant cells 200 to vary. Thus, a larger plant may be accommodated by moving two clamps 196 further apart from one another. FIG. 4B shows a top plan view of two adjacent clamps 196 in which a groove 198 is formed in each so that when the two clamps 196 are placed together, the opposing grooves 198 define an opening for the plant to grow through as it matures. In the illustrated embodiment, the opposing grooves 198 are each semicircular in shape and therefore the opening is circular when the two clamps 196 are joined in an abutting manner. The clamps 196 also provide desired structural support for the plants as they grow within the plant holding member 190.

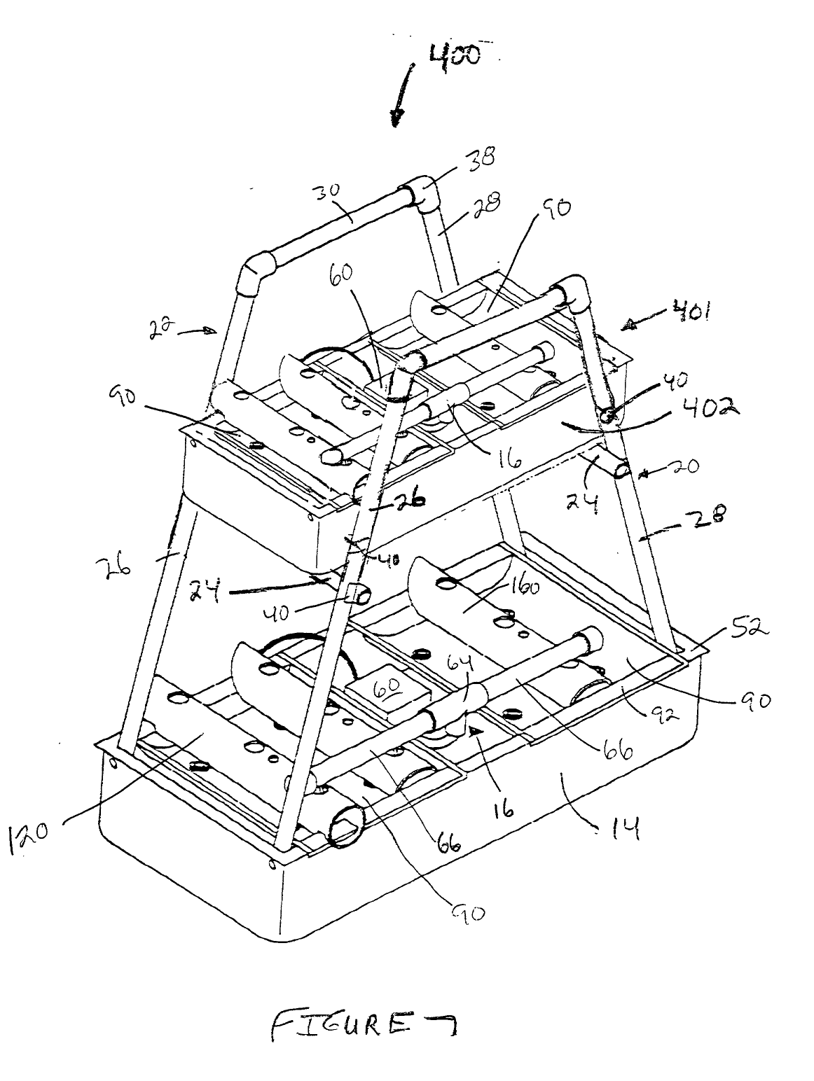

Referring now to FIGS. 2 and 5. FIG. 5 shows an individual plant holding member 210. Plant holding member 210 is formed of a rigid material to provide structural support for the plant 150 and soil material. The plant 150 and soil are disposed within an opening 212 formed in the plant holding member 210. The cross section of the plant holding member 210 may take any number of shapes and in this embodiment, the plant holding member 210 has an annular cross section. At one end 214 thereof, the plant holding member 210 has a number of spaced cut-outs 216 which are designed to permit the nutrient solution to flow underneath the plant holding member 210 and into contact with the plant 150 and soil therewith. These cut-outs 216 thus provide the necessary inlet passageways for the nutrient solution to flow through to provide the plant 150 with the necessary nourishment and water. FIG. 5 shows the plant 150 being disposed in a container 218 which contains the soil and provides some lateral structural support. The individual plant holding members 210 may be disposed within the receptacle 90 so that the one ends 214 thereof seat on the bottom surface 91 of the receptacle 90.

As shown in FIGS. 1 and 2, the solution distribution assembly 16 is positioned between two receptacles 90 so that the main distributor member 64 is parallel to walls 95 of the receptacle 90 and the side distributor members 66 extend across the length of the reservoir member 14 towards end walls 15 thereof. While, one plant holding member 120 and a pair of plant holding members 160 are shown within respective receptacles 90, it will be appreciated that the members 120, 160 may be disposed between side walls 17 of the reservoir member 14 so long as the members 120, 160 are fed nutrient solution by the solution distribution assembly 16. The versatility and ability to modify the growing environment allows the apparatus 10 to be individually configured depending upon the user's wishes and needs. Another advantage of the apparatus 10 is that it is a self-contained system and is portable so that it may be easily transported or moved to another location. The frame 12 is designed to be easily disassembled and then reassembled to permit easy packing of the apparatus 10 for transportation thereof.

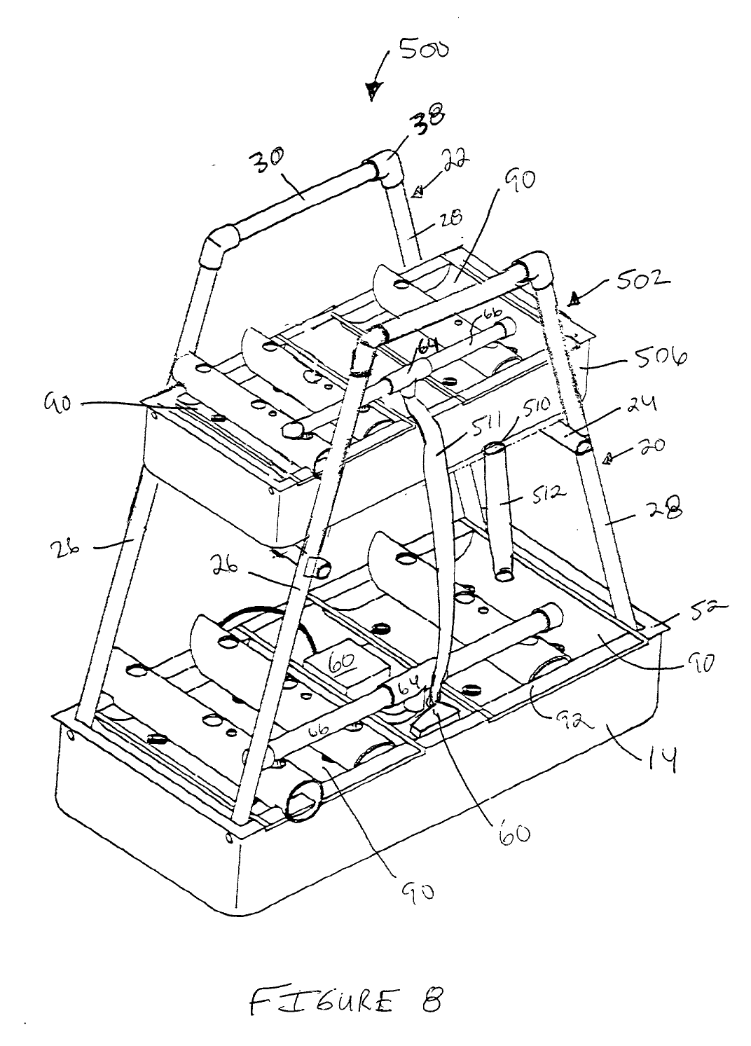

FIG. 6 shows an apparatus 300 according to a second embodiment of the present invention. Apparatus 300 is essentially identical to apparatus 10 with the exception that the frame is modified. Apparatus 300 includes a frame 302 having a first frame member 304 and a second frame member 306. In this embodiment, the first and second frame members 304, 306 are single members which are flexed accordingly to fit between ends walls 15 of the reservoir member 14 and more specifically, first and second ends 308, 310 of each of the first and second frame members 304, 306 is secured to respective end walls 15. Thus, each of the first and second frame members 304, 306 is bent so as to resemble an arch structure which provides excellent structural properties (tension) and permits the apparatus 300 to be easily gripped and transported.

Referring to FIGS. 1-7. FIG. 7 shows an apparatus 400 according to a third embodiment of the present invention. Apparatus 400 is similar to apparatus 10; however, the apparatus 400 comprises a two tiered hydroponic garden apparatus with the second tier assembly being generally indicated at 401. A second reservoir member 402 is provided and extends across the cross support members 24. The second reservoir member 402 is preferably affixed to the first and second vertical members 26, 28 by using clamps 40 as previously described with reference to securing the cross support members 24 in FIG. 1. The second reservoir member 402 may be identical to or different than the reservoir member 14 and is designed to hold and circulate nutrient solution. In one embodiment, the second tier assembly 401 is also self-contained in that a second pump 60 is provided in the second reservoir member 402 for circulating the nutrient solution into one or more receptacles 90 via the solution distribution assembly 16 which communicates with the second reservoir member 402. In this embodiment, a light fixture (not shown) may also extend across the apparatus 400 by disposing the light fixture underneath the second reservoir member 402. Of course, it will be appreciated that the light fixture may be directly attached to the first and second vertical members 26, 28 instead of resting on the cross support members 24.

It will also be appreciated that any number of plant holding members 120, 160, 180, 190, and 210 may be used in the second tier assembly 401 so that the nutrient solution is distributed to plants disposed therein. The nutrient solution within the second tier assembly 401 may be the same nutrient solution as used in the bottom reservoir member 14 or because of the self-contained, independent nature of the second tier assembly 401, the nutrient solution may be different. This may be advantageous in a setting where plants can be separated into two groups where a first group requiring first growing conditions is disposed in the bottom assembly (reservoir member 14, etc.) and a second group of plants requiring second growing conditions are disposed in the second tier assembly 401.

It is understood that additional embodiments of the present invention include various numbers of reservoir members and thus provided a multiple tier hydroponic growing assembly, fully adaptable according to an operator's preferences.

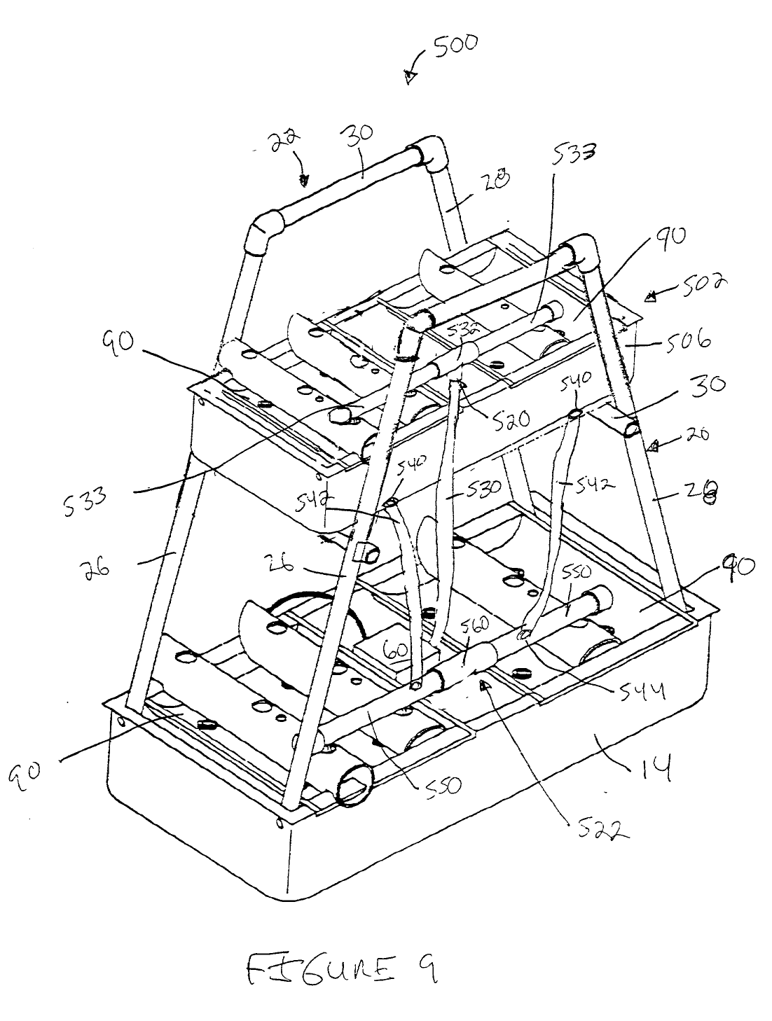

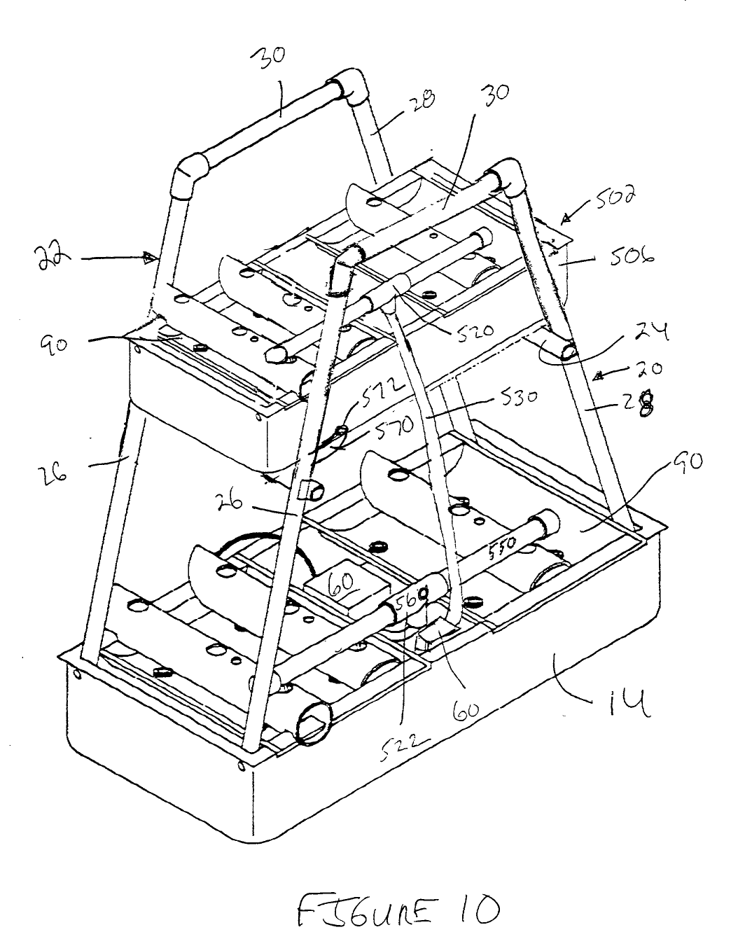

Now referring to FIGS. 8-9 in which another embodiment of the present invention is shown. A two-tier apparatus 500 is provided and is similar to apparatus 400 of FIG. 7 with the exception that a second tier assembly 502 of apparatus 500 is not independent from reservoir member 14 and the solution distribution assembly 16 contained therein. In other words, the solution distribution assembly 16 disposed in the reservoir member 14 is used to provide nutrient solution to both the reservoir member 14 and to a second reservoir member 506 which forms a part of the second tier assembly 502. There are two possible ways of providing nutrient solution to both tiers. First, the reservoir member 14 may contain two separate pumps 60 with one pump 60 pumping solution to the second tier assembly 502 via a feed conduit 511, i.e. tubing, and the other pump 60 providing solution to selected areas of the one or more receptacles 90 and/or plant holding members 120, 160, 180, 190, 210 associated with the bottom tier (reservoir member 14). Thus, two separate solution distribution assemblies 16 are used as shown. The second reservoir member 506 includes a number of drainage openings 510 formed therein for permitting the nutrient solution to drain from the second reservoir member 506 to the reservoir member 14. Preferably, each drainage opening 510 has a conduit member 512 which extends downwardly from the drainage opening 510 towards the reservoir member 14. The conduit member 512 may comprise any number of members and in one embodiment comprises a tubular member which focuses the nutrient solution and directs the solution into the one or more receptacles 90 which are part of the reservoir member 14. From there, the nutrient solution is circulated back into the reservoir member 14 and is recirculated by pump 60.

Second and with reference to FIG. 9, the apparatus 500 may be designed so that only one pump 60 is placed in the reservoir member 14 and serves to pump nutrient solution to both the second tier assembly 502 and the bottom tier assembly. In this embodiment a first solution distribution assembly 520 is provided with the second tier assembly 502 and an interconnected second solution distribution assembly 522 is provided for the bottom tier assembly. The pump 60 acts to pump nutrient solution up from the reservoir member 14 to the first solution distribution assembly 520 via a fluid carrying member 530, e.g., tubing. The fluid carrying member 530 then connects with a main distributor member 532 which directs the nutrient solution into two side distributor members 533 which serve to distribute the nutrient solution. The side distributor members 533 have a number of outlets (not shown) formed therein and preferably tubing (not shown) as previously described with reference to other embodiments. The second reservoir member 506 has one and preferably two or more outlets 540 for directing the nutrient solution to the second solution distribution assembly 522. Each outlet 540 has a fluid connector 542 which carries the nutrient solution from the second reservoir member 506 to the second solution distribution assembly 522. In one embodiment, the fluid connectors 542 comprise tubing, preferably flexible, which carries the nutrient solution and connects at one end to inlet ports 544 formed on a pair of side distribution members 550 of the second distribution assembly 522. The second distribution assembly 522 which has a number of outlets 82 formed therein for distributing the nutrient solution to receptacles 90 and any plant holding members disposed therein. A main distribution connector 560 may be used to permit attach one or more side distribution members 550 thereto so that the side distribution members 550 may be changed depending upon the application. This permits the user to increase or decrease the length of the side distribution members 550 and make any other desired substitutions.

In yet another embodiment shown in FIG. 10, the manner in which the nutrient solution is drained from the second reservoir member 506 to the reservoir member 14 is modified. The conduit member 512 is eliminated and instead at least one of the first and second vertical members 26, 28 of at least one of the first and second frame members 20, 22 is used to carry the nutrient solution from the second reservoir member 506 to the reservoir member 14. A connector 570 is used to provide fluid communication between the second reservoir member 506 and at least one of the first and second vertical members 26, 28. For example and as illustrated in FIG. 10, the connector 570 comprises tubing which sealingly mates at one end with a port opening 572 formed in the second reservoir member 506 and sealingly mates with the first vertical member 26 of the first frame member 20. Because the first vertical member 26 comprises a hollow tubular member, the nutrient solution flows therethrough and is discharged into the reservoir member 14. This embodiment advantageously eliminates additional drainage tubing extending downward from the second reservoir member 506 for draining the nutrient solution to the reservoir member 14. By taking advantage of the frame member itself as a fluid conduit, the visible flow of nutrient solution is eliminated. It will be appreciated that in this embodiment, the nutrient solution is distributed to the top tier assembly 502, i.e., first solution distribution assembly 520 via the fluid carrying member 530 by using another pump 60. It is also within the scope of the present invention that a feed line (not shown) may be provided to direct nutrient solution from the first vertical member 26 to the second solution distribution assembly 522 which will then distribute the nutrient solution along the receptacles 90 and plant holding members 120, 160, 180, 190, 210 as previously described. In this design, a single pump 60 may be used to initially distribute nutrient solution to the first solution distribution assembly 520 before the nutrient solution is distributed to the second solution distribution assembly 522 via the first vertical member 26.

It will be appreciated that the reservoir members may also be used to hold fish, frogs, and the like. In addition, the receptacle members used to house the plants may also be used as an aquatic environment for living organisms.

Operation of the present apparatus is quite simple and straightforward, requiring only minimal actions by the operator. Of course, the nutrient solution must be periodically replenished and it is desirable to occasionally rinse and clean the apparatus. It will be seen that the present invention does not depend upon gravity for distributing the nutrient solution throughout the apparatus and more specifically to all of the plant cells. The apparatus is easily broken down to a more convenient size and thus may be transported or shipped. The compactness and self-contained aspect of the present invention permit the apparatus to be used in a variety of locations including in any room of a house or in a greenhouse setting. In addition, the aeration provided by the apparatus provides excellent growth conditions.

Still further, the apparatus allows adaptability by the operator according to specific preferences. For example, lighting and the height, positioning, and intensity thereof, are easily adjusted in the present invention. The number of growth receptacles and nutrient reservoirs is readily varied by an operator. And even the growing technique may be altered, for example, from pressurized to ebb and flow to nutrient film, as desired by the operator.

Finally, the apparatus is of a construction and a design which allows easy and inexpensive manufacture, production, maintenance, and use.

While preferred embodiments have been shown and described, various modifications and substitutions may be made thereto without departing from the spirit and scope of the invention. Accordingly, it is understood that the present invention has been described by way of illustrations and not limitation.

What is claimed is:

1. A hydroponic garden apparatus comprising:
a frame;
a reservoir for holding a nutrient solution;
one or more members for holding plants;
a distribution assembly for delivering the nutrient solution from the reservoir to the one or more members for holding plants so that the nutrient solution is discharged over a surface of the one or more members for providing water and nourishment to the plants.

2. The apparatus of claim 1, wherein the one or more members for holding plants include drainage means for allowing the nutrient solution discharged over the surface to drain to the reservoir to provide constant circulation of the nutrient solution.

3. The apparatus of claim 1, wherein the frame includes a front section and a rear section with one or more cross support members extending therebetween.

4. The apparatus of claim 3, further including a light assembly supported by the one or more cross support members.

5. The apparatus of claim 1 wherein said distribution assembly is a pressurized system comprising:
a pump;
an intake member; and
a distributor member;
wherein said pump creates a flow of said nutrient solution from the reservoir to the distributor member through the intake member; and
wherein said distributor member directs said flow to the surface of the one or more members for holding plants.

6. The apparatus of claim 5 wherein the distributor member includes at least one extension portion which extends over the surface of the one or more members for holding plants.

7. The apparatus of claim 5, wherein the distributor member includes tubing to specifically direct the flow to the surface of the one or members for holding plants.

8. A hydroponic garden apparatus comprising:
a frame;
a first reservoir for holding a nutrient solution, the frame being secured to the first reservoir;
one or more first receptacles for holding plants, the one or more first receptacles being disposed across the first reservoir so that the nutrient solution is below the one or more first receptacles;
a distribution assembly for delivering the nutrient solution from the reservoir to the one or more first receptacles so that the nutrient solution is discharged over a surface of the one or more first receptacles for providing water and nourishment to the plants; and
a pair of cross support members extending between the frame.

9. The apparatus of claim 8, further comprising:
a second reservoir for holding the nutrient solution, the second reservoir extending between the frame above the cross support members; and
one or more second receptacles for holding plants, the one or more second receptacles being disposed across the second reservoir so that the nutrient solution is below the one or more second receptacles;
wherein the nutrient solution is delivered to the one or more second receptacles from the first reservoir and then is circulated back to the first reservoir for constant circulation of the nutrient solution through the first and second receptacles.

10. The apparatus of claim 9, wherein the first receptacle includes a first drainage means for allowing the nutrient solution delivered to the first receptacle to drain to the first reservoir, and wherein the second receptacle includes a second drainage means for allowing the nutrient solution delivered to the second receptacle to drain to the second reservoir.
